(19) United States
(12) Patent Application Publication
(10) Pub. No.: US 2024/0105953 A1
(43) Pub. Date: Mar. 28, 2024

(54) POSITIVE ELECTRODE SLURRY, POSITIVE ELECTRODE SHEET, AND LITHIUM BATTERY

(71) Applicant: XIAMEN HITHIUM ENERGY STORAGE TECHNOLOGY CO., LTD., Xiamen (CN)

(72) Inventor: Renjie QU, Xiamen (CN)

(21) Appl. No.: 18/531,744

(22) Filed: Dec. 7, 2023

Related U.S. Application Data
(63) Continuation of application No. PCT/CN2022/141259, filed on Dec. 23, 2022.

(30) Foreign Application Priority Data
May 11, 2022 (CN) 202210512735.7

(51) Int. Cl. H01M 4/62; C01B 25/45; C01G 51/00; C01G 53/00; H01M 4/131; H01M 4/58

(52) U.S. Cl. CPC H01M 4/622; C01B 25/45; C01G 51/42; C01G 53/44; H01M 4/131; H01M 4/5825; H01M 4/625; H01M 2004/028

(57) ABSTRACT

Provided is a positive electrode slurry, a positive electrode sheet, and a lithium battery. The positive electrode slurry includes a positive electrode active material, a conductive agent, an aqueous binder, and a functional additive, wherein the functional additive has at least one of —NR³⁺, —SO₃²⁻, —PO₄³⁻, —CO—, —O—, and —NH₂, where R is an alkyl group.

### CROSS-REFERENCE TO RELATED APPLICATIONS

This application is a continuation of International Application No. PCT/CN2022/141259, filed on Dec. 23, 2022, which claims priority to Chinese Patent Application No. 202210512735.7 filed before the China National Intellectual Property Administration on May 11, 2022 and entitled “POSITIVE ELECTRODE SLURRY POSITIVE ELECTRODE SHEET, AND LITHIUM BATTERY”, which is incorporated herein by reference in its entirety.

### FIELD

The present disclosure belongs to the field of batteries, and specifically relates to a positive electrode slurry, a positive electrode sheet, and a lithium battery.

### BACKGROUND

The positive electrode materials of traditional lithium-ion battery usually adopt polyvinylidene fluoride as a binder, which needs to be dissolved in an organic solvent before being coated on a current collector. The organic solvent is not only costly, but during a coating process, it is also accompanied by volatilization. Therefore, this will not only affect the health of workers, but also cause environmental pollution. Usually, in order to solve the problem of environmental pollution and reduce costs, enterprises usually set up their own organic solvent recovery towers in battery factories. Although the cost will be reduced to a certain extent, with a development of the battery cell technology, the cost is still not ideal.

In recent years, more and more researchers are trying to replace the oil-based system of the lithium-ion battery positive electrode with an aqueous system. Aqueous binders are commonly used, but a homogenization of an aqueous positive electrode system with a single-component positive electrode aqueous binder is difficult. Usually gel will be formed within 10 minutes after homogenization, making it difficult to carry out the coating process. Moreover, the coated electrode sheet is brittle and hard, and has a low cold-pressed density. A winding of the coated electrode sheet is difficult, and the rolled battery core is prone to break when folded inward, which affects mechanical properties of the electrode sheet, and then affects electrochemical performance of the lithium-ion battery.

### SUMMARY

In one aspect of the present disclosure, the present disclosure provides a positive electrode slurry. According to an embodiment of the present disclosure, the positive electrode slurry includes a positive electrode active material, a conductive agent, an aqueous binder, and a functional additive, wherein the functional additive has at least one of —NR³⁺, —SO₃²⁻, —PO₄³⁻, —CO—, —O—, and —NH₂, where R is an alkyl group.

In a second aspect of the present disclosure, the present disclosure provides a positive electrode sheet. According to an embodiment of the present disclosure, the positive electrode sheet includes: a positive electrode current collector; a positive electrode active substance layer, the positive electrode active substance layer being formed on a surface of the positive electrode current collector, and the positive electrode active substance layer being formed by using the above-mentioned positive electrode slurry.

In a third aspect of the present disclosure, the present disclosure provides a lithium battery. According to an embodiment of the present disclosure, the lithium battery includes the above-mentioned positive electrode sheet. Therefore, the lithium battery has a low internal resistance and excellent cycle performance.

Additional aspects and advantages of the present disclosure will be provided at least in part in the following description, or will become apparent at least in part from the following description, or can be learned from the practice of the present disclosure.

### DETAILED DESCRIPTION

Embodiments of the present disclosure are described in detail below, which are intended to explain the present disclosure and are not to be construed as to limit the present disclosure.

In one aspect of the present disclosure, the present disclosure provides a positive electrode slurry. According to an embodiment of the present disclosure, the positive electrode slurry includes a positive electrode active material, a conductive agent, an aqueous binder, and a functional additive, wherein the functional additive has at least one of —NR³⁺, —SO₃²⁻, —PO₄³⁻, —CO—, —O—, and —NH₂, where R is an alkyl group.

The inventors found that by adding the aqueous binder and the functional additive (the functional additive includes at least one of the following groups: —NR³⁺, —SO₃²⁻, —PO₄³⁻, —CO—, —O—, and —NH₂) to the positive electrode slurry, in the process of mixing the positive electrode slurry, these functional additives are strongly adsorbed on the surface of the positive electrode active material particles through interactions such as ionic bonds, covalent bonds, or hydrogen bonds. That is, a coating layer is formed on the surface of the positive electrode active material particles. The coating layer inhibits a strong force between the aqueous binder and the positive electrode active material particles, thus effectively improving the problem that gel is prone to generate during the homogenization process of the slurry. At the same time, the above-mentioned positive electrode slurry, which includes the aqueous binder and the functional additives mixed with the positive electrode active particles and the conductive agent, is coated on the surface of the positive electrode current collector to form a positive electrode sheet. Due to the special functional group structure in the functional additive, a dispersion ability between the positive electrode active material particles and the binder is increased. At the same time, the functional addictive can self-repair the voids caused by solvent evaporation due to its low molecular weight, reducing a shrinkage stress when the slurry is dried, and allowing the positive electrode sheet to have softness and toughness while maintaining excellent bonding performance. Therefore, the mechanical properties of the electrode sheet can be improved, the problems such as floating powder and winding fragments that are easily generated when the electrode sheet is s cut can be avoided, and the electrical performance of the lithium-ion battery can be ensured. In addition, the positive electrode slurry of the present disclosure uses water as a solvent, which effectively reduces environmental pollution and eliminates potential health risks for workers.

According to an embodiment of the present disclosure, a mass ratio of the aqueous binder to the functional additive in the above-mentioned positive electrode slurry is 1:(0.02˜0.1). The inventors found that if the amount of the aqueous binder added is too high, the gel of the slurry will not be improved significantly; if the amount of the aqueous binder added is too low, the stability of the slurry will be affected; if the amount of the functional additive added is too high, the bonding force of the electrode sheet will be lost; and if the amount of the functional additive added is too low, the gel improvement and the toughness improvement of the electrode sheet will be insufficient. Therefore, the combination the aqueous binder and the functional additive according to the above-mentioned ratio can improve the stability of the positive electrode slurry while improving the gel of the slurry and the toughness of the electrode sheet. Further, the above-mentioned aqueous binder is formed by polymerizing at least one of acrylic acid, acrylonitrile, methyl methacrylate, methyl acrylate, ethyl acrylate, butyl acrylate, hydroxyethyl acrylate, methacrylic acid, and acrylamide. For example, the aqueous binder is formed by copolymerizing butyl acrylate, acrylonitrile, and acrylamide. The inventors found that the aqueous binder obtained by this combination can allow the electrode sheet to have high bonding force while further improving the flexibility of the electrode sheet with the increase of the amount of soft monomers added. Meanwhile, a molar ratio of butyl acrylate, acrylonitrile to acrylamide in the copolymerized aqueous binder is (40˜60):(20˜40):(10˜30).

According to an embodiment of the present disclosure, the functional additive above has a molecular weight of 200˜100000, for example, 10000˜30000. The inventors found that if the molecular weight of the functional additive is too high, the solvent voids cannot be effectively filled when the electrode sheet is dried, and the electrode sheet is prone to shrinking itself, resulting in warping or cracking of the electrode sheet; and if the molecular weight of the functional additive is too low, the functional additive may be taken away with the evaporation of the solvent, and cannot play a role of toughening. Therefore, by adopting functional additive in the above molecular weight range, the electrode sheet may be toughened while avoiding warping or cracking of the electrode sheet. Further, the above-mentioned functional additive includes but are not limited to at least one of polyamine, polyvinylpyrrolidone, and polyether.

According to an embodiment of the present disclosure, a mass ratio of the positive electrode active material, the conductive agent to a sum of the aqueous binder and the functional additive in the above-mentioned positive electrode slurry is (94˜98):(0.5˜6):(2˜5). Further, the average particle size D50 of the positive electrode active material ranges from 0.2 μm˜1.5 μm. In addition, the positive electrode active material includes but is not limited to at least one of lithium nickelate, lithium manganate, lithium cobaltate, lithium manganese phosphate, lithium vanadium phosphate, lithium iron phosphate, nickel cobalt aluminum lithium oxide, and nickel cobalt manganese lithium oxide; and the conductive agent includes but is not limited to at least one of acetylene black, Super P, carbon nanotubes, graphene, and conductive carbon fiber.

In a second aspect of the present disclosure, the present disclosure provides a positive electrode sheet. According to an embodiment of the present disclosure, the positive electrode sheet includes a positive electrode current collector and a positive electrode active substance layer. The positive electrode active substance layer is formed on the surface of the positive electrode current collector, and the positive electrode active substance layer is formed by using the above-mentioned positive electrode slurry. The inventors found that by coating the above-mentioned positive electrode slurry, which includes the aqueous binder, the functional additives, the positive electrode active particles, and the conductive agent, on the surface of the positive electrode current collector to form a positive electrode sheet, due to the special functional group structure in the functional additive, a dispersion ability between the positive electrode active material particles and the binder is increased. At the same time, the functional addictive can self-repair the voids caused by solvent evaporation due to its low molecular weight, reducing a shrinkage stress when the slurry is dried, and allowing the positive electrode sheet to have flexibility and toughness while maintaining excellent bonding performance. Therefore, the mechanical properties of the electrode sheet can be improved, the problems such as floating powder and winding fragments that are easily generated when the electrode sheet is slit can be avoided, and the electrical performance of the lithium-ion battery can be ensured. In addition, the positive electrode slurry of the present disclosure uses water as a solvent, which effectively reduces environmental pollution and eliminates potential health risks for workers.

It may be noted that the features and advantages described above for the positive electrode slurry are equally applicable to the positive electrode sheet, and will not be described again herein.

In a third aspect of the present disclosure, the present disclosure provides a lithium battery. According to an embodiment of the present disclosure, the lithium battery includes the above-mentioned positive electrode sheet. Therefore, the lithium battery has a low internal resistance and excellent cycle performance.

It may be noted that the features and advantages described above for the positive electrode sheet are equally applicable to the lithium battery, and will not be described again herein.

Examples of the present disclosure are described in detail below. It may be noted that the examples described below are exemplary and are only used to explain the present disclosure and cannot be understood as limiting the present disclosure. In addition, if not explicitly stated, all reagents used in the following examples are commercially available or can be synthesized according to the methods herein or known, and for reaction conditions not listed, they are also readily available to those skilled in the art.

### Example 1

The positive electrode slurry included: 96.5 wt % lithium iron phosphate, 2.5 wt % binder, and 1 wt % acetylene black. Wherein the average particle size D50 of the lithium iron phosphate is 1.2 μm, and the binder included an aqueous binder polyacrylic acid and a functional additive polyvinylpyrrolidone. A mass ratio of polyacrylic acid to functional additive polyvinylpyrrolidone was 1:0.07, and a molecular weight distribution width of polyvinylpyrrolidone was 12000˜15000.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 2

The positive electrode slurry included: 96.5 wt % lithium iron phosphate, 2.5 wt % binder, and 1 wt % acetylene black. Wherein the average particle size D50 of the lithium iron phosphate is 1.2 μm, and the binder included an aqueous binder polyacrylic acid and a functional additive polyvinylpyrrolidone. A mass ratio of polyacrylic acid to functional additive polyvinylpyrrolidone was 1:0.07, and a molecular weight distribution width of polyvinylpyrrolidone was 20000˜30000.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 3

The positive electrode slurry included: 96.5 wt % lithium iron phosphate, 2.5 wt % binder, and 1 wt % acetylene black. Wherein the average particle size D50 of the lithium iron phosphate is 1.2 μm, and the binder included an aqueous binder polyacrylic acid and a functional additive polyvinylpyrolidone. A mass ratio of polyacrylic acid to functional additive polyvinylpyrrolidone was 1:0.1, and a molecular weight distribution width of polyvinylpyrrolidone was 12000˜15000.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 4

The positive electrode slurry included: 96.8 wt % lithium iron phosphate, 2 wt % binder, and 1.2 wt % acetylene black. Wherein the average particle size D50 of the lithium iron phosphate is 0.8 μm, and the binder included an aqueous binder (formed by copolymerizing butyl acrylate, acrylonitrile, and acrylamide) and a functional additive sodium lauroyl glutamate. A mass ratio of the aqueous binder to the functional additive is 1:0.07.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 5

The positive electrode slurry included: 96.8 wt % lithium iron phosphate, 2 wt % binder, and 1.2 wt % acetylene black. Wherein the average particle size D50 of the lithium iron phosphate is 0.8 μm, and the binder included an aqueous binder (formed by copolymerizing butyl acrylate, acrylonitrile, and acrylamide) and a functional additive sodium alkyl benzene sulfonate. A mass ratio of the aqueous binder to the functional additive is 1:0.07.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 6

The positive electrode slurry included: 95.5 wt % lithium iron phosphate, 2.8 wt % binder, and 1.7 wt % acetylene black. Wherein the average particle size D50 of the lithium iron phosphate is 0.8 μm, and the binder included an aqueous binder (formed by copolymerizing butyl acrylate, acrylonitrile, and acrylamide) and a functional additive isomeric alcohol phosphate. Amass ratio of the aqueous binder to the functional additive is 1:0.07.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 7

The positive electrode slurry included: 95.5 wt % lithium iron phosphate, 2.8 wt % binder, and 1.7 wt % acetylene black. Wherein the average particle size D50 of the lithium iron phosphate is 0.8 μm, and the binder included an aqueous binder (formed by copolymerizing butyl acrylate, acrylonitrile, and acrylamide) and a functional additive polyether. A mass ratio of the aqueous binder to the functional additive is 1:0.07, and a molecular weight distribution width of the functional additive was 18000˜25000.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 8

The positive electrode slurry included: 95.5 wt % lithium iron phosphate, 2.8 wt % binder, and 1.7 wt % acetylene black. Wherein the average particle size D50 of the lithium iron phosphate is 0.8 μm, and the binder included an aqueous binder (formed by copolymerizing butyl acrylate, acrylonitrile, and acrylamide) and a functional additive diethylenetriamine. A mass ratio of the aqueous binder to the functional additive is 1:0.07, and a molecular weight distribution width of the functional additive was 18000˜25000.

Preparation method of the positive electrode sheet: the above-mentioned positive electrode slurry was coated on both surfaces of the aluminum foil, and the aluminum foil was cold-pressed after the coating was completed, then the positive electrode active substance layer could be formed on the surface of the aluminum foil (a thickness of the double-sided coating was 240 μm).

Preparation of battery cell: the battery cell was assembled with the above-mentioned positive electrode sheet as the positive electrode, graphite as the negative electrode, PP film as the separator, and commercial common lithium iron phosphate electrolyte as the electrolyte.

### Example 9

The positive electrode active material was lithium cobaltate, the conductive agent was graphene, the aqueous binder was polymethyl acrylate, and the rest was the same as in Example 8.

### Example 10

The positive electrode active material was nickel cobalt manganese lithium oxide, the conductive agent was carbon nanotubes, the aqueous binder was polymethacrylic acid, and the rest was the same as in Example 8.

### Example 11

The aqueous binder was polyacrylamide, and the rest was the same as in Example 8.

### Example 12

The aqueous binder was formed by copolymerizing acrylic acid and acrylonitrile, and the rest was the same as in Example 8.

### Example 13

The aqueous binder was formed by copolymerizing methyl acrylate and acrylamide, the rest was the same as in Example 8.

### Comparative Example 1

The positive electrode slurry included: 96.5 wt % lithium iron phosphate, 2.5 wt % binder polyacrylic acid, and 1 wt % acetylene black. Wherein the average particle size D50 of the lithium iron phosphate is 1.2 μm, and the rest was the same as in Example 1.

### Comparative Example 2

The positive electrode slurry included: 96.5 wt % lithium iron phosphate, 2.5 wt % binder (formed by copolymerizing butyl acrylate, acrylonitrile, and acrylamide), and 1 wt % acetylene black. Wherein the average particle size D50 of the lithium iron phosphate is 1.2 μm, and the rest was the same as in Example 1.

The state of the positive electrode slurry, the flexibility of the positive electrode sheet, the peeling force of the positive electrode sheet, and the DCR performance of the battery cell obtained in Examples 1-13 and Comparative Examples 1-2 were evaluated. The evaluation results are shown in Table 1.

Table 1. The state of the positive electrode slurry, the flexibility of the positive electrode sheet, the peeling force of the positive electrode sheet, and the Direct Current Resistance (DCR) performance of the battery cell obtained in Examples 1-13 and Comparative Examples 1-2

| | The state | The flexibility | The peeling force | Battery |
|---|---|---|---|---|
| | of the | of the | of the positive | cell |
| | positive | positive | electrode sheet | DCR |
| | electrode slurry | electrode sheet | (N/m) | (50% SOS) |
| Example 1 | No gel was found | No obvious | 8.6 | 18.4 |
| | after mixing for 2 | material loss was | | |
| | hours | found in winding | | |
| Example 2 | No gel was found | No obvious | 10.4 | 17.8 |
| | after mixing for 4 | material loss was | | |
| | hours | found in winding | | |
| Example 3 | No gel was found | No obvious | 9.2 | 18.6 |
| | after mixing for 2 | material loss was | | |
| | hours | found in winding | | |
| Example 4 | No gel was found | Slight material | 8.6 | 18.2 |
| | after mixing for 2 | loss when | | |
| | hours | winding is folded | | |
| | | inward | | |
| Example 5 | No gel was found | Slight material | 7.8 | 18.8 |
| | after mixing for 2 | loss when | | |
| | hours | winding is folded | | |
| | | inward | | |
| Example 6 | No gel was found | Slight material | 8.3 | 18.6 |
| | after mixing for 2 | loss in winding is | | |
| | hours | folded inward | | |
| Example 7 | No gel was found | No obvious | 11.5 | 18.3 |
| | after mixing for 4 | material loss was | | |
| | hours | found in winding | | |
| Example 8 | No gel was found | No obvious | 18.2 | 16.2 |
| | after mixing for 7 | material loss was | | |
| | hours | found in winding, | | |
| | | and the electrode | | |
| | | sheet had good | | |
| | | toughness | | |
| Example 9 | No gel was found | No obvious | 15.7 | 11.2 |
| | after mixing for 10 | material loss was | | |
| | hours | found in winding, | | |
| | | and the electrode | | |
| | | sheet had good | | |
| | | toughness | | |
| Example 10 | No gel was found | No obvious | 15.2 | 9.1 |
| | after mixing for 8 | material loss was | | |
| | hours | found in winding, | | |
| | | and the electrode | | |
| | | sheet had good | | |
| | | toughness | | |
| Example 11 | No gel was found | There was | 6.2 | 18.9 |
| | after mixing for 3 | material loss in | | |
| | hours | winding | | |
| Example 12 | No gel was found | There was | 5.8 | 18.2 |
| | after mixing for 4 | material loss in | | |
| | hours | winding | | |
| Example 13 | No gel was found | There was | 6.7 | 19.6 |
| | after mixing for 3 | material loss in | | |
| | hours | winding, and the | | |
| | | electrode sheet | | |
| | | was hard and | | |
| | | brittle | | |
| Comparative | Gel appeared at the | Large area of | 4.3 | 22.1 |
| Example 1 | time of | material loss at | | |
| | discharging | the crease when | | |
| | after mixing | electrode sheet | | |
| | | was folded in half | | |
| Comparative | No gel was found | Material loss at | 5.1 | 21.3 |
| Example 2 | after mixing for 30 | the crease when | | |
| | minutes | electrode sheet | | |
| | | was folded in half | | |
| | | twice | | |

In the description of this specification, the description of the reference terms such as “an embodiment”, “some embodiments”, “example”, “specific example”, or “some examples” means that the specific features, structures, materials or characteristics described in conjunction with the embodiment or example are included in at least an embodiment or example of the present disclosure. In this specification, exemplary descriptions of the foregoing terms do not necessarily refer to the same embodiment or example. Moreover, the specific features, structures, materials, or characteristics described may be combined in any one or more embodiments or examples in a suitable manner. Furthermore, those skilled in the art may combine and integrate different embodiments or examples and features of different embodiments or examples described in this specification unless they are contradictory with each other.

The embodiments of the present disclosure have been described above in conjunction with the accompanying drawings. However, the present disclosure is not limited to the above-mentioned specific embodiments. The above-mentioned specific embodiments are only exemplary and not restrictive. Many forms can be made by those skilled in the art inspired by the present disclosure without departing from the purpose of the present disclosure and the scope of the protection of the claims, and all of which fall within the protection of the present disclosure.

What is claimed is:

1. A positive electrode slurry, comprising a positive electrode active material, a conductive agent, an aqueous binder, and a functional additive, wherein the functional additive has at least one of —NR³⁺, —SO₃²⁻, —PO₄³⁻, —CO—, —O—, and —NH₂, where R is an alkyl group.

2. The positive electrode slurry according to claim 1, wherein a mass ratio of the aqueous binder to the functional additive is 1:(0.02˜0.1).

3. The positive electrode slurry according to claim 1, wherein the aqueous binder is formed by polymerizing at least one of acrylic acid, acrylonitrile, methyl methacrylate, methyl acrylate, ethyl acrylate, butyl acrylate, hydroxyethyl acrylate, methacrylic acid, and acrylamide.

4. The positive electrode slurry according to claim 1, wherein the aqueous binder is formed by copolymerizing butyl acrylate, acrylonitrile, and acrylamide.

5. The positive electrode slurry according to claim 1, wherein the functional additive has a molecular weight of 200˜100000.

6. The positive electrode slurry according to claim 1, wherein the functional additive has a molecular weight of 10000˜30000.

7. The positive electrode slurry according to claim 1, wherein the functional additive comprises at least one of polyamine, polyvinyl pyrrolidone, and polyether.

8. The positive electrode slurry according to claim 1, wherein a mass ratio of the positive electrode active material, the conductive agent to a sum of the aqueous binder and the functional additive is (94˜98):(0.5˜6):(2˜5).

9. The positive electrode slurry according to claim 1, wherein an average particle size D50 of the positive electrode active material ranges from 0.2 μm˜1.5 μm.

10. The positive electrode slurry according to claim 1, wherein the positive electrode active material comprises at least one of lithium nickelate, lithium manganate, lithium cobaltate, lithium manganese iron phosphate, lithium vanadium phosphate, lithium iron phosphate, nickel cobalt aluminum lithium oxide, and nickel cobalt manganese lithium oxide.

11. The positive electrode slurry according to claim 1, wherein the conductive agent comprises at least one of acetylene black, Super P, carbon nanotubes, graphene, and conductive carbon fiber.

12. A positive electrode sheet, comprising:
a positive electrode current collector;
a positive electrode active substance layer, the positive electrode active substance layer being formed on a surface of the positive electrode current collector, and the positive electrode active substance layer being formed by using a positive electrode slurry. the positive electrode slurry comprising a positive electrode active material, a conductive agent, an aqueous binder, and a functional additive, wherein the functional additive has at least one of —NR³⁺, —SO₃²⁻, —PO₄³⁻, —CO—, —O—, and —NH₂, where R is an alkyl group.

13. The positive electrode sheet according to claim 12, wherein a mass ratio of the aqueous binder to the functional additive is 1:(0.02˜0.1).

14. The positive electrode sheet according to claim 12, wherein the aqueous binder is formed by copolymerizing butyl acrylate, acrylonitrile, and acrylamide.

15. The positive electrode sheet according to claim 12, wherein the functional additive comprises at least one of polyamine, polyvinyl pyrrolidone, and polyether.

16. The positive electrode sheet according to claim 12, wherein a mass ratio of the positive electrode active material, the conductive agent to a sum of the aqueous binder and the functional additive is (94˜98):(0.5˜6):(2˜5).

17. A lithium battery, comprising a positive electrode sheet, the positive electrode comprising:
a positive electrode current collector;
a positive electrode active substance layer, the positive electrode active substance layer being formed on a surface of the positive electrode current collector, and the positive electrode active substance layer being formed by using a positive electrode slurry.
the positive electrode slurry comprising a positive electrode active material, a conductive agent, an aqueous binder, and a functional additive, wherein the functional additive has at least one of —NR³⁺, —SO₃²⁻, —PO₄³⁻, —CO—, —O—, and —NH₂, where R is an alkyl group.

18. The lithium battery according to claim 17, wherein a mass ratio of the aqueous binder to the functional additive is 1:(0.02˜0.1).

19. The lithium battery according to claim 17, wherein the aqueous binder is formed by copolymerizing butyl acrylate, acrylonitrile, and acrylamide.

20. The lithium battery according to claim 17, wherein the functional additive comprises at least one of polyamine, polyvinyl pyrrolidone, and polyether.
